(19) United States
(12) Patent Application Publication
(10) Pub. No.: US 2001/0013326 A1
(43) Pub. Date: Aug. 16, 2001

(54) Cylinder head for an internal combustion engine

(75) Inventors: Takashi Komatsuda, Saitama (JP); Kaoru Aoki, Saitama (JP); Shinichi Takahashi, Saitama (JP); Takuya Takagi, Saitama (JP); Hiromu Nakamura, Saitama (JP); Tsutomu Yamasaki, Saitama (JP)

Correspondence Address: ARENT FOX KINTNER PLOTKIN & KAHN, PLLC, 1050 Connecicut Avenue, N.W. , Suite 600, Washington, DC, 20036-5339, US

(73) Assignee: HONDA GIKEN KOGYO KABUSHIKI KAISHA

(21) Appl. No.: 09/779,630

(22) Filed: Feb. 9, 2001

(30) Foreign Application Priority Data
Feb. 10, 2000 (JP) P. 2000-034166

(51) Int. Cl. F02F 1/00

(52) U.S. Cl. 123/193.5

(57) ABSTRACT

In a cylinder head 1 of an internal combustion engine, communicating passageways 17, 18, 17′, 18′ for coolant are provided between combustion chambers 3 and pass-through holes 21 to 28 at positions which overlap straight lines L1, L2 connecting centers C2, C3 of the exhaust port openings 6a, 7a with centers C5 to C8 of the pass-through holes 25 to 28 and straight lines L3, L4 connecting centers C9, C10 of the intake port openings 4a, 5a with centers C11 to c14 of the pass-through holes 21 to 24 when a mating surface 2 of the cylinder head 1 with the cylinder block is viewed from the bottom. When peripheries of the exhaust port openings 6a, 7a and intake port openings 4a, 5a thermally expand, the suppression of thermal expansion by the bolts at fastening portions is alleviated by the communicating passageways 17, 18, 17′, 18′.

### BACKGROUND OF THE INVENTION

1. Field of the Invention

The present invention relates to a cylinder head for an internal combustion engine, and more particularly to a cylinder head construction for a cylinder head having pass-through holes through which fasteners are passed for fastening the cylinder head to a cylinder block so as to suppress the deformation of intake port openings which are opened and/or closed by intake valves due to thermal expansion at the periphery of the intake port openings, or the deformation of exhaust port openings which are opened and/or closed by exhaust valves due to thermal expansion at the periphery of the exhaust port openings.

2. Description of the Related Art

In an internal combustion engine, a cylinder head having provided therein intake port openings and exhaust port openings which are opened and/or closed by intake valves and exhaust valves, respectively, is a part of the engine which becomes high-temperature by being exposed to combustion gas, and the peripheries of the intake port openings and the exhaust port openings also become high-temperature. On the other hand, a plurality of fastening bolts pass-through holes are formed in the cylinder head radially outwardly of the intake and exhaust port openings along the peripheries of combustion chambers, whereby the cylinder head is fastened to the cylinder block with fastening bolts which are inserted through the fastening bolts pass-through holes.

Then, the highly heated peripheral portions of the intake and exhaust port openings tend to thermally expand towards the peripheries thereof substantially uniformly. As shown in FIG. 7, however, fastening portions are provided radially outwardly of intake port openings a and exhaust port openings b, which fastening portions are fastened by fastening bolts which are inserted through pass-through holes c. Therefore, when a mating surface of the cylinder head with the cylinder block is viewed from the bottom, the fastening portions restrain thermal expansions in directions along straight lines d connecting centers of the intake port openings a or the exhaust port openings b with centers of the pass-through holes c and in particular thermal expansions in directions along the straight lines d in the vicinity of portions where the peripheral portions of the intake port openings a or the exhaust port openings b overlap the straight lines d. Due to this, the peripheries of the intake port openings a or the exhaust port openings b cannot expand uniformly, whereby the intake port openings a or the exhaust port openings b which are both substantially round are deformed to form an out-of-round shape, and at the same time as this occurs, thermal stress converges on areas f on the peripheries of the intake port openings a or the exhaust port openings b and in the vicinity of portions which overlap straight lines e which pass through the centers of the intake port openings a or the exhaust port openings b and intersect with the straight lines d. Then, creep deformations are generated in the areas f due to the thermal stress, and this causes the intake port openings a or the exhaust port openings b to be deformed to a more out-of-round shape. Note that reference character g denotes an opening through which a spark plug faces the combustion chamber.

When the intake port openings or the exhaust port openings deform as described above, the sealing properties of the intake valve or the exhaust valve are deteriorated, and this causes a leakage of unburned air-fuel mixture from between the intake valves and the intake port openings, or between the exhaust valves and the exhaust port openings during a compression stroke. Then, in the event that unburned air-fuel mixture leaks from between the intake valves and the intake port openings, since fuel flows back to the intake ports, the accuracy at which the air-fuel ratio is controlled may be badly affected, while in the even that unburned air-fuel mixture leaks from between the exhaust valves and the exhaust port openings, the amount of HC in exhaust gas increases, resulting in deterioration in exhaust emissions.

Then, in order to prevent the reduction in sealing properties of the intake valves or exhaust valves resulting from the deformation of the intake port openings or exhaust port openings due to thermal expansions or creep deformation in the peripheral portions of the intake or exhaust port openings, conventionally, a certain limit is imposed on the maximum combustion temperature of the internal combustion engine or the capacity of the coolant jacket in the cylinder head is increased so as to improve the cooling performance, whereby the deformation of the intake port openings or exhaust port openings is suppressed to thereby secure the sealing properties of the intake or exhaust valves.

Limiting the maximum combustion temperature of an internal combustion engine, however, sets a limit to the output of the engine, and in the case of an automotive internal combustion engine, for example, the running performance of an automotive vehicle is limited which incorporates an internal combustion engine whose maximum combustion temperature is limited. Thus, since limiting the maximum combustion temperature of an internal combustion engine leads to limiting the operating performance of an apparatus incorporating the internal combustion engine, an improvement thereto has been desired. In addition, the enlargement of the cooling mechanism with a view to improving the cooling performance such as increasing the capacity of the cooling water jacket leads to the enlargement of the cylinder head, this limiting the degree of freedom in the layout of the internal combustion engine.

### SUMMARY OF THE INVENTION

The present invention was made in view of these situations and an object thereof is to maintain a high engine output with a simple construction and to secure good sealing properties of intake or exhaust valves without the enlargement of a cylinder head being involved.

According to a first aspect of the invention, there is provided a cylinder head for an internal combustion engine adapted to be fastened to a cylinder block with the fasteners, the cylinder head comprising combustion chambers, intake port openings and exhaust port openings which are opened and/or closed by intake valves and exhaust valves, respectively, pass-through holes through which fasteners are passed, and, space portions provided between the combustion chambers and the pass-through holes at positions which overlap straight lines connecting centers of the intake port openings or the exhaust port openings with the pass-through holes when a mating surface of the cylinder head with the cylinder block is viewed from the bottom.

According to the first aspect of the invention, when the peripheries of the intake port openings or the exhaust port openings are thermally expanded, the suppression of thermal expansion by the fastening portions on the cylinder head where the cylinder head is fastened to the cylinder block with fasteners is alleviated by the space portions in the peripheries of the intake port openings or exhaust port openings in the vicinity of the portions which overlap the straight lines when the mating surface of the cylinder head with the cylinder block is viewed from the bottom thereof, and therefore the thermal expansions being permitted, the peripheries of the intake port openings or exhaust port openings thermally expand in the directions along the straight lines. Due to this, the deformation of the intake port openings or exhaust port openings based on the suppression of thermal expansion by the fastening portions on the cylinder head is suppressed. Moreover, the convergence of thermal stress occurring by the suppression of thermal expansion can be reduced in areas in the vicinity of portions in the peripheries of the intake port openings or exhaust port openings which overlap straight lines passing through the centers of the intake port openings or exhaust port openings and intersecting with the straight lines substantially at right angles, whereby the intake port openings or exhaust port openings are allowed to maintain shapes close to their substantially round shapes provided before the peripheries of the intake port openings or exhaust port openings are thermally expanded.

As a result, even when the peripheries of the intake port openings or exhaust port openings are thermally expanded, with the simple construction in which the space portions are provided in the cylinder head, good sealing properties of the intake valves or exhaust valves can be secured. This suppresses the leakage of unburned air-fuel mixture into the intake port openings during compression strokes, whereby the accuracy at which the air-fuel ratio is controlled can be maintained properly. In addition, similarly, the above construction suppresses the leakage of unburned air-fuel mixture into the exhaust ports during compression strokes, whereby exhaust emissions can be improved. Moreover, combustion at as high a maximum combustion temperature as the thermal expansion is permitted by the space portions is possible, whereby a high engine output can be maintained. Furthermore, there is no risk that the cylinder head is enlarged, whereby there is imposed no limitation to the layout of the internal combustion engine.

According to a second aspect of the invention, since the degree of alleviation of the suppression of thermal expansion by the fastening portions on the cylinder block can be substantially equalized on sides of the straight lines, the peripheries of the intake port openings or exhaust port openings can be thermally expanded more uniformly, whereby the shapes of the intake port openings or exhaust port openings can be maintained to those which are closer to the substantially round shapes. As a result, in addition to the effectiveness provided by the first aspect of the invention, better sealing properties of the intake valves or exhaust valves can be secured, whereby the accuracy at which the air-fuel ratio is controlled can be maintained good, and the exhaust emissions can be further improved.

According to a third aspect of the invention, there is provided a cylinder head for an internal combustion engine, as set forth in the first and second aspects of the invention, wherein the space portions constitute coolant passageways.

According to the third aspect of the invention, the suppression of thermal expansion by the fastening portions on the cylinder head is alleviated by the coolant passageways which are constituted by the space portions, and at the same time, the peripheries of the intake port openings or exhaust port openings are cooled with coolant flowing through the space portions, whereby the thermal expansions themselves in the peripheries of the intake port openings or exhaust port openings can be reduced. Therefore, since the deformation of the intake port openings or exhaust port openings and the occurrence of the convergence of thermal stress can be suppressed further, the shapes of the intake port openings or exhaust port openings can be maintained to those closer to their substantially round shapes provided before the peripheries of the intake port openings or exhaust port openings are thermally expanded.

As a result, in addition to the effectiveness provided by the first and second aspects of the invention, with the simple construction in which the coolant passageways are constituted by the space portions, much better sealing properties of the intake valves or exhaust valves can be secured, the accuracy at which the air-fuel ratio is controlled can be maintained better, and the exhaust emissions can be improved much better.

### BRIEF DESCRIPTION OF THE DRAWINGS

FIG. 1 is a plan view of a first embodiment of the invention as viewed from a mating surface of a cylinder head of an internal combustion engine;

FIG. 2 is a sectional view taken along the line II-II of FIG. 1;

FIG. 3 is a sectional view taken along the line III-III of FIG. 1;

FIG. 4 is a sectional view taken along the line IV-IV of FIG. 1;

FIG. 5 is a view corresponding to FIG. 4 which shows a second embodiment of the invention;

FIG. 6 is a view corresponding to FIG. 4 which shows a third embodiment of the invention; and

FIG. 7 is an explanatory view showing portions in peripheries of intake port openings and exhaust port openings where thermal stress is generated.

### DETAILED DESCRIPTION OF THE PREFERRED EMBODIMENTS

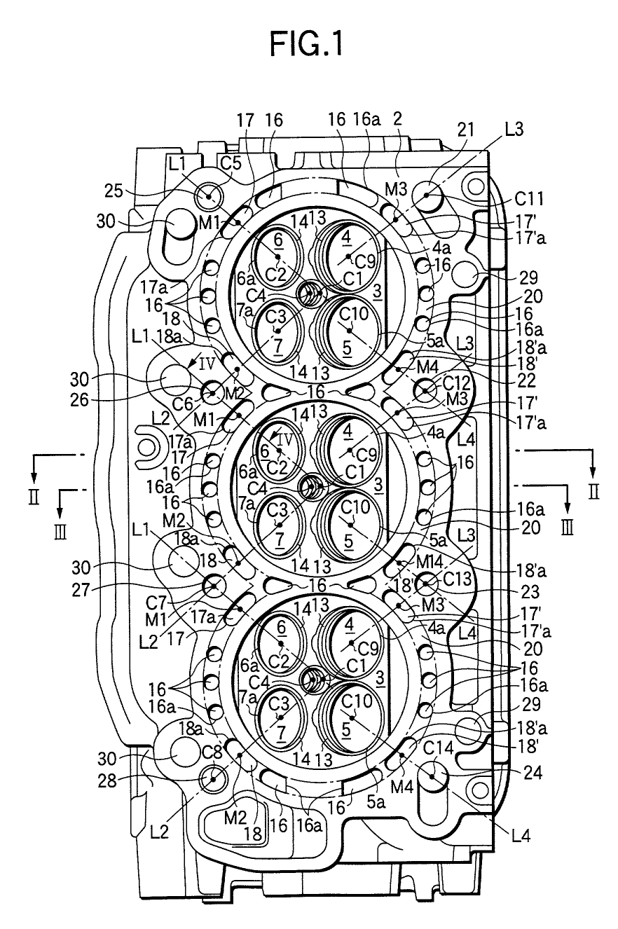

Referring to FIGS. 1 to 5 a description will be given of embodiments of the invention.

In a first embodiment, an internal combustion engine is a V-6 spark ignition SOHC water-cooled internal combustion engine which is adapted to be equipped on an automotive vehicle. The internal combustion engine comprises a cylinder block of aluminum alloy which has a pair of banks arranged in a V-shape and a pair of cylinder heads of aluminum alloy which is fastened to the respective banks of the cylinder block. FIG. 1 shows a mating surface 2 of the cylinder head 1 of one of the pair of banks which mates with the cylinder block (not shown). Note that in the following description, while mainly the cylinder head 1 and the cylinder block on one of the pair of banks will be described, the cylinder head and the cylinder block on the other bank are basically constructed in the same way.

Each of the banks of the cylinder block has three cylinder portions arranged along an axial direction of a crankshaft rotatably supported on the cylinder block, and the cylinder head 1 has three pent roof type combustion chambers 3 which are concaved in the cylinder head 1 and are arranged in the axial direction of the crankshaft (hereinafter, referred to as the “arrangement direction”) so as to face cylinder bores formed in the respective cylinder portions for pistons to fit therein, respectively, for reciprocating movement.

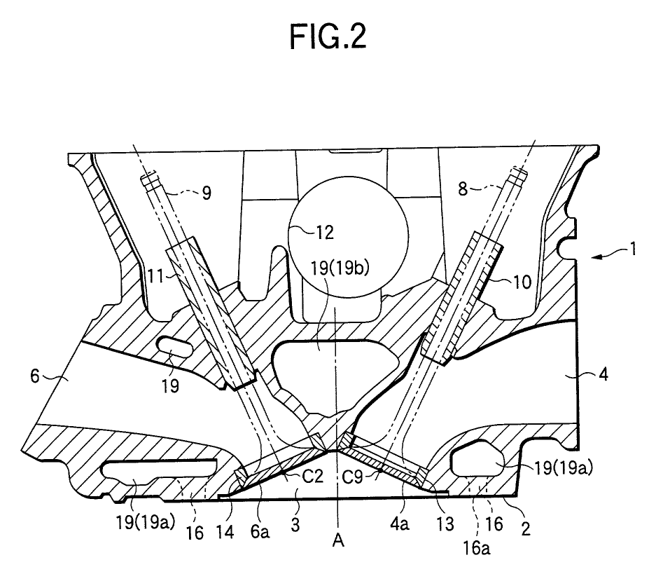

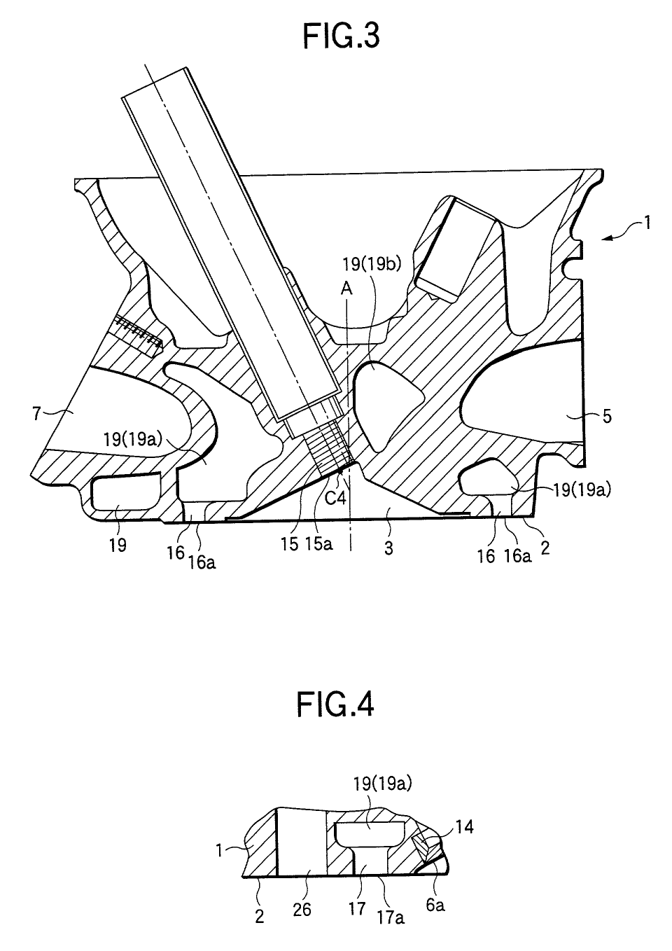

Referring to FIGS. 2 and 3 in combination, formed in each combustion chamber 3 are substantially round intake port openings 4a, 5a which are combustion chamber 3 side opening ends of a pair of intake ports 4, 5 provided in the cylinder head 1 and are opened and/or closed by a pair of intake valves 8 and substantially round exhaust port openings 6a, 7a which are combustion chamber 3 side opening ends of a pair of exhaust ports 6, 7 which are provided in the cylinder head 1 and are opened and/or closed by a pair of exhaust valves 9.

The intake valves 8 inclined toward the intake ports 4, 5 side relative to a center line A of the cylinder bore and the exhaust valves 9 inclined toward the exhaust ports 6, 7 side relative to the same center line A are operated to be opened and/or closed by a valve train comprising a camshaft (not shown) rotatably supported in a supporting hole 12 provided in the cylinder head 1 and rocker arms adapted to be rocked by cams provided on the camshaft, the intake valves 8 and the exhaust valves 9 being slidably fitted, respectively, in guide tubes 10, 11 which are press fitted in the cylinder head 1. This valve train is disposed in a valve chamber formed by being tightly closed by a cylinder head cover fastened to the cylinder head 1. In addition, valve seats 13, 14 are press fitted in the respective intake port openings 4a, 5a and the respective exhaust port openings 6a, 7a for the intake valves 8 and the exhaust valves 9 to sit thereon.

On a combustion chamber wall surface of each combustion chamber 3, the intake port openings 4a, 5a are disposed along the arrangement direction and closer to the center of the V-shape formed by the two banks, while the exhaust port openings 6a, 7a are disposed along the arrangement direction and closer to a side end of the V-shape. Furthermore, an opening 15a of a mounting hole 15 for a spark plug (not shown) is provided substantially centrally of the combustion chamber wall surface at a position surround by both the intake valves 8 and the exhaust valves 9. This mounting hole 15 is located at substantially a center between the two exhaust valves 9 and has a center line inclined toward the exhaust ports 6, 7 relative to the center line A of the cylinder bore (refer to FIG. 3).

Provided in the cylinder head 1 so as to surround the respective combustion chambers 3 is a head side coolant jacket 19 which is caused to communicate with a block side coolant jacket provided in the cylinder block into which coolant delivered under pressure from a coolant pump is supplied via a plurality of communicating passageways 16 . . . , 17, 18, 17′, 18′, so that coolant from the block side coolant jacket enters and passes through the head side coolant jacket.

These communicating passageways 16 . . . , 17, 18, 17′, 18′ constituting coolant passageways are constructed by through holes which are disposed radially outwardly of the center line A relative to the combustion chamber 3 and at certain intervals along the circumferential direction of the combustion chamber 3, and one ends of the respective communicating passageways 16 . . . , 17, 18, 17′, 18′ form openings 16a . . . , 17a, 18a, 17′a, 18′a in the mating surface 2 of the cylinder head 1, whereas the other ends thereof are made to open to the head side coolant jacket 19. Furthermore, the respective communicating passageways 16 . . . , 17, 18, 17′, 18′ extend substantially along the center line A, and the cross-sectional areas and shapes of the respective communicating passageways 16 . . . , 17, 18, 17′, 18′ approximately remain identical to those of the respective openings 16a . . . , 17a, 18a, 17′a, 18′a at most of the planes parallel to the mating surface 2. Then, the openings 16a . . . , 17a, 18a, 17′a, 18′a of the respective communicating passageways 16 . . . , 17, 18, 17′, 18′ face coolant passageways formed in a gasket provided between the cylinder block and the cylinder head 1, so that coolant can flow from the block side coolant jacket into the head side coolant jacket 19. In addition, these openings 16a . . . , 17a, 18a, 17′a, 18′a are disposed on the mating surface 2 within the extent of an annular belt portion 20 (shown by chain double-dashed lines) which has a certain width in the radial direction around the center line A.

The head side coolant jacket 19 comprises a coolant passageway 19a having an annular shape which surrounds the combustion chamber 3 in the circumferential direction and to which the communicating passageways 16 . . . , 17, 18, 17′, 18′, open and a coolant passageway 19b extending between the intake ports 4, 5 and the exhaust ports 6, 7 in the arrangement direction, and these coolant passageways 19a, 19b communicate with each other.

On the other hand, pass-through holes 21 to 28 through which fastening bolts (not shown) are passed for fastening the cylinder head 1 to the cylinder block are provided radially outwardly of the annular belt portion 20 and are arranged at the side of the combustion chamber 3 and in the arrangement direction with four of them on the intake ports 4, 5 side and the other four on the exhaust ports 6, 7 side.

Of these pass-through holes 21 to 28, centers C5 to C8 of the pass-through holes 25 to 28 on the exhaust ports 6, 7 side are located substantially on straight lines L1, L2 which connect the center C1 of a cylinder bore and centers C2, C3 of exhaust port openings 6a, 7a, respectively, for each combustion chamber 3, when the mating surface 2 is viewed from the bottom. In addition, of the pass-through holes 25 to 28, the centers C6, C7 of the pass-through holes 26, 27 which are located between the adjacent combustion chambers 3 are located, respectively, at intersection points of the straight lines L1, L2 and the straight lines L2, L1 which pass, respectively, through the centers C2, C3 of the exhaust port openings 6a, 7a and the centers of the exhaust port openings 7a, 6a of the adjacent combustion chambers 3, one of the exhaust port openings being one of the exhaust port openings of one of the adjacent combustion chambers 3 which is located closer to the other combustion chamber, and the other exhaust port opening being one of the exhaust port openings of the other combustion chamber which is located closer to the one of the adjacent combustion chambers 3.

Additionally, the pass-through holes 21 to 24 on the intake ports 4, 5 side are provided in the mating surface 2 at positions which are substantially line symmetry relative to a line of intersection between a plane including the mating surface 2 and a plane including the center line A. Here, let's assume that straight lines connecting centers C11, C12 of the pass-through holes 21, 22, centers C12, C13 of the pass-through holes 22, 23 and centers C13, C14 of the pass-through holes 23, 23 for the respective combustion chambers 3 with centers C9, C10 of the intake port openings 4a, 5a of the respective combustion chambers 3 are referred to as straight lines L3, L4, respectively, when the mating surface 2 is viewed from the bottom. Then, the centers C12, C13 of the pass-through holes 22, 23 which are located between the adjacent combustion chambers 3 are located at intersection points of the straight lines L3, L4 and the straight lines L4, L3 which pass, respectively, through the centers C9, C10 of the intake port openings 4a, 5a and the centers of the intake port openings 5a, 4a of the adjacent combustion chambers 3, one of the intake port openings being one of the intake port openings of one of the adjacent combustion chambers 3 which is located closer to the other combustion chamber, and the other intake port opening being one of the exhaust port openings of the other combustion chamber which is located closer to the one of the adjacent combustion chambers 3.

Additionally, of the pass-through holes 21 to 24 on the intake ports 4, 5 side, the two pass-through holes 21, 24 which are positioned at ends of the mating surface 2 of the cylinder head 1 in the arrangement direction also function as passageways for supplying lubricating oil for lubrication of the valve train. Furthermore, of the pass-through holes 25 to 28 on the exhaust ports 6, 7 side, the two pass-through holes 25, 28 which are positioned at the ends of the mating surface 2 of the cylinder head 1 also function as pass-through holes through which cylindrical positioning pins disposed coaxially around the outer circumference of the fastening bolt are to be passed. Note that reference numeral 29 denotes two through holes constituting breather passageways and reference numeral 30 denotes four return passageways for lubricating oil.

With each combustion chamber 3, as shown in FIGS. 1 and 4, the two communicating passageways 17, 18 on the exhaust ports 6, 7 side and the two communicating passageways 17′, 18′ on the intake ports 4, 5 side constitute space portions provided in the cylinder head 1 and are located between the combustion chamber 3 and the pass-through holes 25 to 28 on the exhaust ports 6, 7 side and between the combustion chamber 3 and the intake ports 4, 5 side, respectively, at positions which overlap the four straight lines L1, L2, L3, L4 when the mating surface 2 is viewed from the bottom. The straight lines L1, L2, L3, L4 pass through M1, M2, M3, M4 which are substantially central positions of the respective communicating passageways 17, 18, 17′, 18′ in the width direction thereof which is normal to the straight lines L1, L2, L3, L4 (hereinafter, referred to as an “orthogonal direction”).

In this first embodiment, widths of the cross sections of the communicating passageways 17, 18, 17′, 18′ in the orthogonal direction including the openings 17a, 18a, 17′a, 18′a are set slightly smaller than the inside diameters of the exhaust port openings 6a, 7a and the intake port openings 4a, 5a, respectively, and the widths thereof are determined appropriately with a view to permitting thermal expansions in the peripheries of the exhaust port openings 6a, 7a and the intake port openings 4a, 5a, which will be described later, to thereby suppress the deformation of the exhaust port openings 6a, 7a and the intake port openings 4a, 5a which is attributed to thermal expansion. Similarly, widths of the cross sections of the communicating passageways 17, 18, 17′, 18′ in the direction of the respective straight lines L1,L2, L3, L4 are determined appropriately from the same structural point of view. Due to this, there may be a case where the areas and shapes of the openings 17a, 18a, 17′a, 18′a of the communicating passageways 17, 18, 17′, 18′ differ from those of portions of the communicating passageways other than the openings 17a, 18a, 17′a, 18′a.

Operation and Effectiveness of the first embodiment of the invention constructed as described heretofore will be described below.

The peripheries of the exhaust port openings 6a, 7a and the intake port openings 4a, 5a of the cylinder head 1 are heated to high temperatures by virtue of combustion of air-fuel mixture in the combustion chambers 3 and thereby expand thermally to a large extent. As this occurs, since the communicating passageways 17, 18, 17′, 18′ acting as the space portions are provided at the positions overlapping the straight lines L1, L2, L3, L4 connecting the centers of the exhaust port openings 6a, 7a and the intake port openings 4a, 5a with the centers of the pass-through holes 25 to 28 and the pass-through holes 21 to 24, the suppression of thermal expansion by the fastening portions of the cylinder head 1 where the cylinder head 1 is fastened to the cylinder block by the fastening bolts is alleviated by the communicating passageways 17, 18, 17′, 18′ in the peripheries of the exhaust port openings 6a, 7a and the intake port openings 4a, 5a, in particular, in the vicinity of the portions which overlap the straight lines L1, L2, L3, L4, whereby the thermal expansion is permitted in directions along the straight lines L1, L2, L3, L4.

This not only suppresses the deformation of the exhaust port openings 6a, 7a and the intake port openings 4a, 5a which is attributed to the suppression of thermal expansion by the fastening portions of the cylinder head 1 but also reduces the concentration of thermal stress generated by the thermal expansion in areas in the vicinity of portions which, in the peripheries of the exhaust port openings 6a, 7a and intake port openings 4a, 5a, overlap straight lines passing through the centers C2, C3, C9, C10 of the exhaust port openings 6a, 7a and intake port openings 4a, 5a and intersecting with the straight lines L1, L2, L3, L4 at substantially right angles, whereby the shapes of the exhaust port openings 6a, 7a and intake port openings 4a, 5a are maintained to shapes which are close to the substantially round shapes prior to the occurrence of thermal expansion.

As a result, with the simple construction in which the communicating passageways 17, 18, 17′, 18′ serving as the space portions are provided in the cylinder head 1, good sealing properties of the exhaust valves 9 and intake valves 8 can be secured, even when the walls of the combustion chambers which include the peripheries of the exhaust port openings 6a, 7a and intake port openings 4a, 5a are thermally expanded. This suppresses the leakage of unburned air-fuel mixture into the intake ports, as well as the exhaust ports during a compression stroke, whereby the good control accuracy can be maintained at which the air-fuel mixture ratio is controlled and the exhaust emissions can be improved. Moreover, since a combustion at a higher maximum combustion temperature is possible within an extent to which the thermal expansion is permitted by the communicating passageways 17, 18, 17′, 18′, the engine output can be maintained high. In addition, since the cylinder head 1 does not have to be enlarged, there is imposed no limitation to the degree of freedom of the layout of the internal combustion engine. Furthermore, since there is no likelihood that the weight of the internal combustion engine is increased due to the enlargement of the cylinder head 1, the fuel economy is deteriorated in no way.

Additionally, since M1, M2, M3, M4 which are substantially the central positions of the widths of the openings 17a, 18a, 17′a, 18′a in the orthogonal direction occupy the positions overlapping the straight lines L1, L2, L3, L4, when the mating surface 2 is viewed from the bottom as described before, the degree of alleviation of suppression of thermal expansion by the fastening portions of the cylinder head 1 is substantially equal on both sides of the straight lines L1, L2, L3, L4, whereby the walls of the combustion chambers including the peripheries of the exhaust port openings 6a, 7a and intake port openings 4a, 5a can expand more uniformly to thereby maintain the shapes of the exhaust port openings 6a, 7a and intake port openings 4a, 5a to shapes which are closer to substantially round shapes. As a result, better sealing properties can be secured for the exhaust valves 9 and the intake valves 8, whereby the good control accuracy can be maintained at which the air-fuel mixture ratio is controlled, and the exhaust emissions can be improved further.

Furthermore, since the communicating passageways 17, 18, 17′, 18′ are coolant passageways, not only is the suppression of thermal expansion by the fastening portions alleviated by the communicating passageways 17, 18, 17′, 18′, but also the entireties of the walls of the combustion chambers 3, in particular, the peripheries of the exhaust port openings 6a, 7a and intake port openings 4a, 5a are cooled by coolant flowing through the communicating passageways 17, 18, 17′, 18′, whereby the thermal expansion at the entireties of the walls of the combustion chambers 3, in particular, the peripheries of the exhaust port openings 6a, 7a and intake port openings 4a, 5a can be reduced to thereby further suppress the deformation of the exhaust port openings 6a, 7a and intake port openings 4a, 5a, as well as the concentration of thermal stress generated in the vicinity of those openings due to the suppression of thermal expansion, thereby making it possible to maintain the shapes of the exhaust port openings 6a, 7a and intake port openings 4a, 5a to shapes which are closer to the substantially round shapes prior to the occurrence of thermal expansion in the peripheries of the exhaust port openings 6a, 7a and intake port openings 4a, 5a.

In addition, although the peripheries of the spark plug mounting holes 15 in the cylinder head 1 where combustion is initiated are also heated to temperatures as high as the peripheries of the exhaust port openings 6a, 7a and intake port openings 4a, 5a, since centers C4 of the spark plug mounting holes 15 are located in the vicinity of the straight lines L1, L2, L3, L4 when the mating surface 2 is viewed from the bottom as described before, the influence of thermal expansions in the peripheries of the spark plug mounting holes 15 in the directions of the straight lines L1, L2, L3, L4 can be reduced by the communicating passageways 17, 18, 17′, 18′, and as a result, the deformation of the exhaust port openings 6a, 7a and intake port openings 4a, 5a resulting from the thermal expansion in the peripheries of the mounting holes 15 can be suppressed.

Described below will be only the constructions of modified portions of an embodiment in which partial modifications are made to the first embodiment.

In the first embodiment, the space portions provided, when the mating surface 2 is viewed from the bottom as described before, at the positions overlapping the straight lines L1, L2 connecting the centers C2, C3 of the exhaust port openings 6a, 7a with the centers C5 to C8 of the pass-through holes 25 to 28 and the straight lines L3, L4 connecting the centers C9, C10 of the intake port openings 4a, 5a with the centers C11 to C14 of the pass-through holes 21 to 24 for absorbing the thermal expansion of the entireties of the walls of the combustion chambers, in particular, in the peripheries of the exhaust port openings 6a, 7a and intake port openings 4a, 5a are the communicating passageways 17, 18, 17′, 18′ consisting of the through holes constituting the coolant passageways. In a second embodiment, as shown in FIG. 5, the space portions may be formed as bottomed recessed portions 40 provided between the combustion chambers 3 and the pass-through holes 25 to 28 and between the combustion chambers 3 and the pass-through holes 21 to 24 and having openings 40a in the mating surface 2. In this case, too, substantially centers of the recessed portions 40 in the orthogonal direction are made to occupy positions overlapping the straight lines L1, L2, L3, L4. Then, the widths in the directions of the straight lines L1, L2, L3, L4 and in the orthogonal directions, depth, area and shape of the cross sections of the recessed portions 40 at planes parallel to the mating surface 2 including the openings 40a thereof are determined appropriately, as with the communicating passageways 17, 18, 17′, 18′, with a view to permitting thermal expansions of the entireties of the walls of the combustion chambers, in particular, in the peripheries of the exhaust port openings 6a, 7a and intake port openings 4a, 5a to thereby suppress the deformation of the entireties of the walls of the combustion chambers, in particular, in the peripheries of the exhaust port openings 6a, 7a and intake port openings 4a, 5a which is attributed to the thermal expansions.

In this second embodiment, too, the same operation and effectiveness as those of the first embodiment can be provided except for the operation and effectiveness provided in the first embodiment by the communicating passageways 17, 18, 17′, 18′ which are the coolant passageways.

Furthermore, while the recessed portions 40 arranged in the directions of the straight lines L1, L2, L3, L4 are located within the extent of an annular belt portion 20 in the second embodiment, they may be located at any positions between the pass-through holes 21 to 28 and the combustion chambers 3. For example, the recessed portions 40 may be located at a position P1 or a position P2 which are both designated by chain double-dashed lines in FIG. 5. Additionally, the recessed portions 40 may be provided such that a plurality of recessed portions 40 are arranged in line with each other in the directions of the straight lines L1, L2, L3, L4 at certain intervals, whereby the degree at which thermal expansion is permitted can be made large by the plurality of recessed portions 40. Furthermore, in another example of constituting the space portions by the recessed portions, the recessed portions may have openings thereof at any positions other than the mating surface 2.

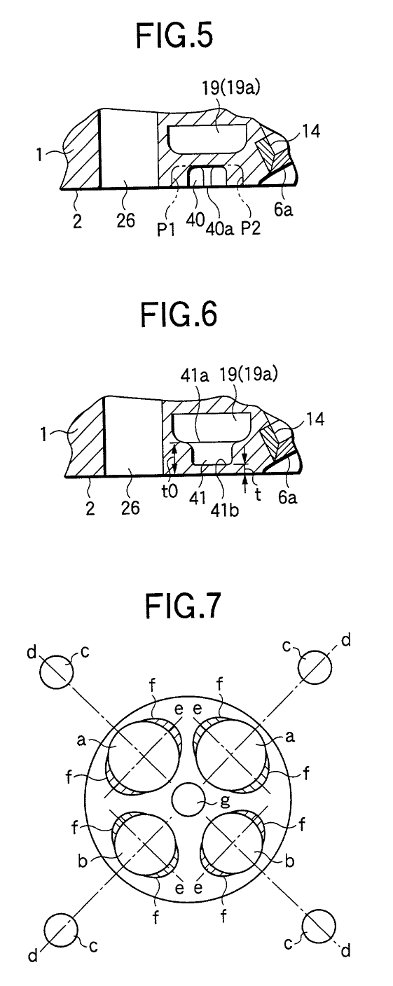

While the communicating passageways 17, 18, 17′, 18′ which overlap the straight lines L1, L2, L3, L4, when the mating surface 2 is viewed from the bottom as described before are disposed within the annular belt portion 20 in the first embodiment, the communicating passageways 17, 18, 17′, 18′ may be provided at any positions in the directions of the straight lines L1, L2, L3, L4 between the combustion chambers 3 and the pass-through holes 21 to 28. Additionally, recessed portions constituting part of the coolant passageways may be provided as coolant passageways 17, 18, 17′, 18′ instead of the communicating passageways which consist of the through holes, and the space portions for permitting thermal expansion may be constituted by the recessed portions. Furthermore, the openings of the recessed portions may be formed in the mating surface 2 or in any portions other than the mating surface 2 which open to the coolant passageway. The latter example will be described below as a third embodiment with reference to FIG. 6.

In the third embodiment which is shown in FIG. 6, recessed portions 41 are provided at the same positions as those where the communicating passageways 17, 18, 17′, 18′ are provided in the first embodiment and have openings 41a which open to an annular coolant passageway 19a surrounding the combustion chambers 3. In this third embodiment, the thickness t between a bottom portion 41b of the recessed portion 41 and the mating surface 2 is made smaller than the thickness t0 between the bottom of portions of the coolant passageway 19a other than the portions thereof where the recessed portions 41 are formed and the mating surface 2, whereby the bottom wall of the recessed portion 41 constitutes a thin bottom wall portion of the coolant passageway 19a. Due to this, the rigidity of the portions of the coolant passageway 19a in the directions of the straight lines L1, L2, L3, L4 which are made thinner by provision of the recessed portions 41 is reduced lower than the rigidity of the portions of the coolant passageway 19a other than those where the recessed portions 41 are formed, and therefore, as with the first embodiment, the suppression of thermal expansion by the fastening portions of the cylinder head 1 is alleviated, and the same operation and effectiveness as those of the first embodiment can be provided.

While the substantially central positions of the widths of the communicating passageways 17, 18, 17′, 18′ or the recessed portions in the orthogonal directions occupy the positions overlapping the straight lines L1, L2, L3, L4 when the mating surface 2 is viewed from the bottom as described above in the respective embodiments, the communicating passageways 17, 18, 17′, 18′ or the recessed portions may be those in which the substantially central positions of the widths thereof in the orthogonal directions do not overlap the straight lines L1, L2, L3, L4 provided that the communicating passageways 17, 18, 17′, 18′ or the recessed portions are located at positions which overlap the straight lines L1, L2, L3, L4, and specific positions thereof are to be determined appropriately with a view to suppressing the deformation of the entireties of the walls of the combustion chambers, in particular, in the peripheries of the exhaust port openings 6a, 7a and intake port openings 4a, 5a which is attributed to the thermal expansions of the entireties of the walls of the combustion chambers, in particular, in the peripheries of the exhaust port openings 6a, 7a and intake port openings 4a, 5a by the provisions of the communicating passageways 17, 18, 17′, 18′ or the recessed portions. Additionally, the areas and shapes of the cross sections of the communicating passageways 17, 18, 17′, 18′ including the openings 17a, 18a, 17′a, 18′a thereof or the areas and shapes of the cross sections of the recessed portions including the openings thereof may be set optionally.

Furthermore, the space portions may be constituted by voids communicating with the outside air or voids which are tightly closed with plugs so as to be blocked off the outside air. In either of the cases, a fluid or a material other than coolant may be loaded in the voids which can suppress the deformation of the exhaust port openings 6a, 7a and intake port openings 4a, 5a by permitting the thermal expansion in the peripheries of the exhaust port openings 6a, 7a and intake port openings 4a, 5a and of the entireties of the walls of the combustion chambers.

In any case, the space portions provided between the combustion chambers 3 and the pass-through holes 21 to 28 may take any form provided that the space portions are such that they are located at the positions which overlap the straight lines L1, L2, L3, L4 when the mating surface 2 is viewed from the bottom as described above, and that the portions having a lower rigidity is formed by providing the space portions so that the suppression of thermal expansion by the fastening portions of the cylinder head 1 is alleviated to thereby permit the thermal expansion of the walls of the combustion chambers, in particular, in the peripheries of the exhaust port openings 6a, 7a and intake port openings 4a, 5a.

While two intake valves 8 and two exhaust valves 9 are provided in each combustion chamber 3 in the respective embodiments, the numbers of intake valves and exhaust valves are not limited to those numbers.

While only certain embodiments of the invention have been specifically described herein, it will apparent that numerous modifications may be made thereto without departing from the spirit and scope of the invention.

What is claimed is:

1. A cylinder head for an internal combustion engine adapted to be fastened to a cylinder block with fasteners, said cylinder head comprising:
at least one of combustion chambers;
at least one of intake port openings and at least one of exhaust port openings which are opened and closed by associated intake and exhaust valves, respectively;
pass-through holes through which said fasteners are passed; and
at least one of space portions provided between said combustion chambers and said pass-through holes at positions which overlap straight lines connecting centers of said intake port openings or said exhaust port openings with centers of said pass-through holes, when a mating surface of said cylinder head with said cylinder block is viewed from the bottom.

2. The cylinder head for an internal combustion engine as set forth in claim 1, wherein substantially transversely central portions of said space portions in a direction orthogonal to said straight lines occupies said positions which overlap said straight lines.

3. The cylinder head for an internal combustion engine as set forth in claim 1, wherein said space portions constitute coolant passageways.

4. The cylinder head for an internal combustion engine as set forth in claim 1, wherein said space portions are disposed within a region of an annular belt portion which is arranged around said combustion chamber on the mating surface and has a predetermined width in a radial direction of said combustion chamber.

5. The cylinder head for an internal combustion engine as set forth in claim 1, wherein said spaced portions are opened to the mating surface of said cylinder head.
